(19) United States
(12) Patent Application Publication
(10) Pub. No.: US 2014/0097934 A1
(43) Pub. Date: Apr. 10, 2014

(54) CONTROL SYSTEM AND METHOD FOR AUTOMATICALLY TURNING ON/OFF DEVICE

(71) Applicant: POWERTECH INDUSTRIAL CO., LTD., New Taipei City (TW)

(72) Inventors: Chien Hsin SU, New Taipei City (TW); YU YUAN CHANG, New Taipei City (TW)

(73) Assignee: POWERTECH INDUSTRIAL CO., LTD., New Taipei City (TW)

(21) Appl. No.: 13/802,980

(22) Filed: Mar. 14, 2013

(30) Foreign Application Priority Data
Oct. 4, 2012 (TW) 101136637

(51) Int. Cl. G08C 17/00

(52) U.S. Cl. CPC G08C 17/00
USPC 340/3.1

(57) ABSTRACT

A control system for automatically turning on/off device including at least an electronic device and a mobile communication device is disclosed. The mobile communication device includes a wireless communication unit and a control unit. The wireless communication unit is configured to be wirelessly connected with the electronic device and transmit the packet signals mutually between each other. The control unit determines whether a connection state between the electronic device and the mobile communication device is normal according to the packet signals. The electronic device is controlled to be turned on when the connection state is normal and turned off when the connection state is abnormal. The connection state may vary in accordance with the variation of the distance between the electronic device and the mobile communication device. Therefore the electronic device may be turned on/off conveniently and more electrical power may be saved.

### BACKGROUND OF THE INVENTION

1. Field of the Invention

The present invention relates to a control system and method thereof; in particular, to a control system for automatically turning on/off device and method thereof.

2. Description of Related Art

There have been many electronic devices that can control an electronic device to be turned on/off by a user operating a remote controller at a distance, in addition to directly operating a power switch on the electronic device. Some typical examples are the television, the fanner, or the air conditioner.

When using the remote controller to control the electronic device to be turned on/off, the user still needs to take the remote controller and respectively send the signal toward each electronic device that is to be turned on, so as to turn on each electronic device. Besides, when turning off the electronic device, the user also needs to take the remote controller and send the signal toward the electronic device for turning off the electronic device. In addition to inconvenience in use, it easily results in a waste of electricity when the user does not need to use the electronic device but forget to turn it off.

### SUMMARY OF THE INVENTION

The object of the exemplary embodiment of the present invention is to provide a control system for automatically turning on/off device comprising a mobile communication device and at least one electronic device. The mobile communication device comprises a wireless communication unit and a control unit. The wireless communication unit is used for wirelessly connecting with the electronic device and making the packet signals transmitted mutually between the mobile communication device and the electronic device. The control unit determines whether the connection state between the mobile communication device and the electronic device is normal according to the packet signals. When the connection state is normal, the control unit controls the electronic device to be turned on. Otherwise, the control unit controls the electronic device to be turned off when the connection state is abnormal. The connection state is varied according to the variation of the distance between the mobile communication device and the electronic device.

Besides, the exemplary embodiment of the present invention further provides a method for automatically turning on/off device, wherein the method is about a mobile communication device controlling at least one electronic device to be turned on/off, and the method comprises: wirelessly connecting the mobile communication device with the electronic device and transmitting the packet signals mutually between the mobile communication device and the electronic device; determining whether the connection state between the mobile communication device and the electronic device is normal according to the packet signals, wherein the connection state is varied according to the variation of the distance between the mobile communication and the electronic device; turning on the electronic device when the connection state is normal, and turning off the electronic device when the connection state is abnormal.

As described above, the exemplary embodiment of the present invention provides a control system and method for automatically turning on/off device, in which the variation of the distance between the mobile communication device and the controlled electronic device is used to automatically control the electronic device to be turned on/off. Thereby when the user of the mobile communication device moves close to the electronic device, the electronic device is automatically turned on and can be used. Otherwise, the electronic device is automatically turned off when the user of the mobile communication device moves away from the electronic device, so as to save the electricity.

In order to further the understanding regarding the present invention, the following embodiments are provided along with illustrations to facilitate the disclosure of the present invention.

### BRIEF DESCRIPTION OF THE DRAWINGS

FIG. 1 shows a block diagram illustrating a control system for automatically turning on/off device;

FIG. 2 shows a schematic view illustrating a control system for automatically turning on/off device;

FIG. 3 shows a block diagram illustrating another control system for automatically turning on/off device;

FIG. 4 shows a schematic view illustrating another control system for automatically turning on/off device;

FIG. 5-1 and FIG. 5-2 show a flow chart of a method for automatically turning on/off device.

### DETAILED DESCRIPTION OF THE PREFERRED EMBODIMENTS

The aforementioned illustrations and following detailed descriptions are exemplary for the purpose of further explaining the scope of the present invention. Other objectives and advantages related to the present invention will be illustrated in the subsequent descriptions and appended drawings.

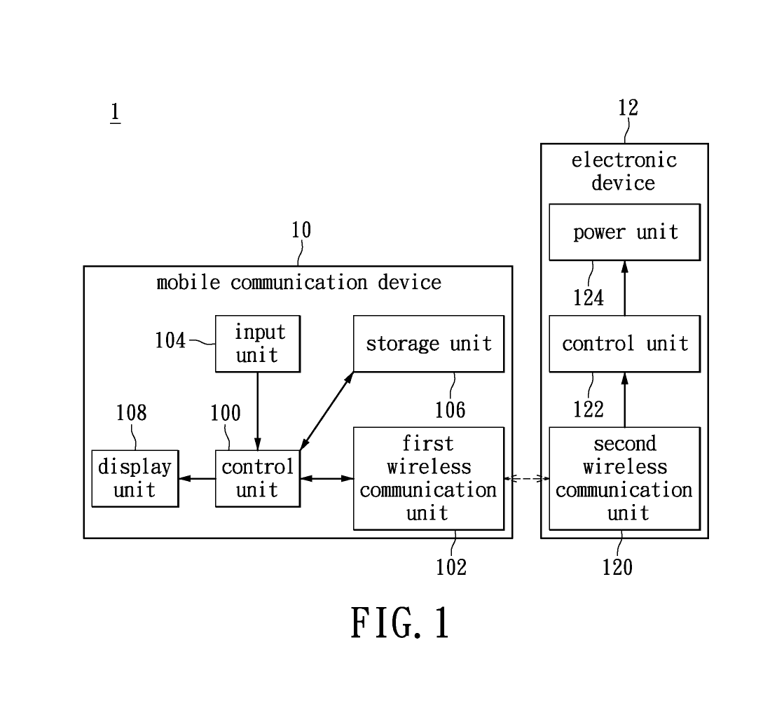

Please refer to FIG. 1. FIG. 1 shows a block diagram illustrating a control system for automatically turning on/off device. A control system 1 for automatically turning on/off device comprises a mobile communication device 10 and at least one electronic device 12. The mobile communication device 10 comprises a control unit 100 and a wireless communication unit (the wireless communication unit is represented as a first wireless communication unit 102 in the following descriptions and figures).

The mobile communication device 10 may be a smart phone, a tablet personal computer containing wireless communication function, etc. The control unit 100 may be a microcontroller or a CPU. The first wireless communication unit 102 may include a Bluetooth unit, a Radio Frequency unit, a Zigbee unit, a Near Field Communication unit, or a Wi-Fi unit, etc. The electronic device 12 may include a wireless communication unit (the wireless communication unit is represented as a second wireless communication unit 120 in the following descriptions and figures) corresponding to the mobile communication device 10, so that the wireless communication unit can be wirelessly connected with the mobile communication device 10 so as to be controlled by the mobile communication device 10.

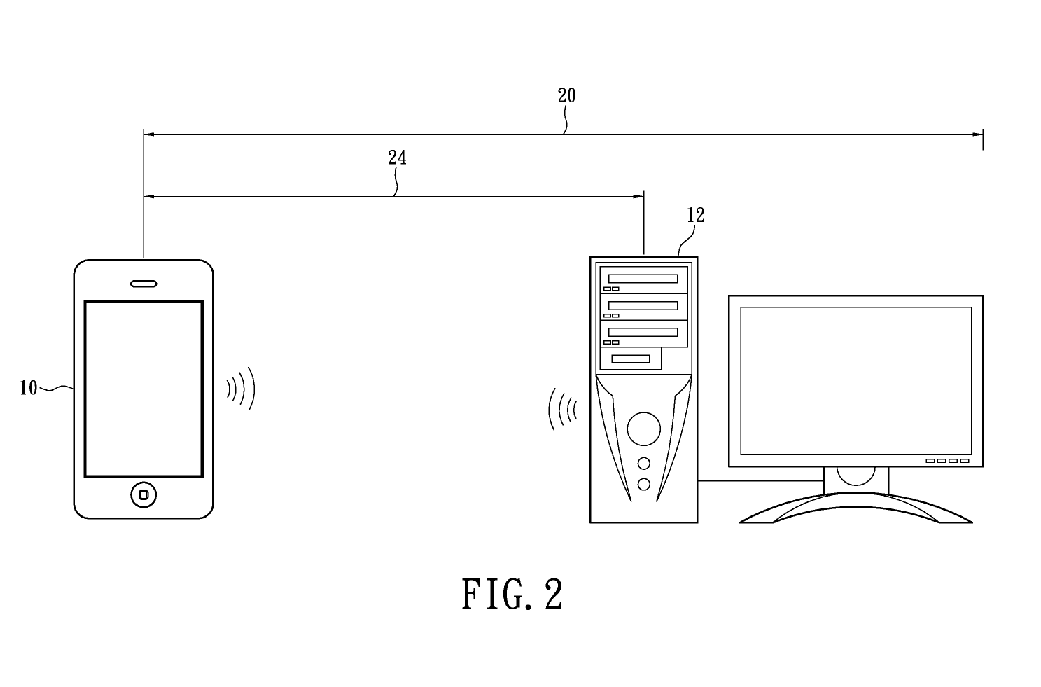

The mobile communication device 10 is wirelessly connected with the electronic device 12 through the first wireless communication unit 102 and the corresponding second wireless communication unit 120 within a connection range. The scope of the connection range is varied according to the communication standard for the first wireless communication unit 102. For example, the connection range of Bluetooth is about 10 meters. The connection range of Zigbee is about between 10 meters and 100 meters. The connection range of Wi-Fi may be in the range of hundreds of meters according to different communication standards adopted. In other words, if the distance between the mobile communication device 10 and the electronic device 12 exceeds the connection range between the first wireless communication unit 102 and the second wireless communication unit 120, the mobile communication device 10 is disconnected with the electronic device 12. Please refer to FIG. 2 in conjunction with FIG. 1. FIG. 2 shows a schematic view illustrating a control system for automatically turning on/off device. The connection range of the mobile communication device 10 is the area enclosed by a circle with a center at the mobile communication device 10 and a radius of the maximum connectable distance 20. Taking the computer as an example of the electronic device 12 shown in FIG. 2, the relative distance 24 between the electronic device 12 and the mobile communication device 10 is smaller than the radius of the connection range, thus the mobile communication device 10 can be wirelessly connected with the electronic device 12 through their respective wireless communication units when both the wireless communication functions of the mobile communication device 10 and the electronic device 12 are enabled.

Refer to FIG. 1 again. After the mobile communication device 10 is wirelessly connected with the electronic device 12, the packet signals are transmitted periodically and mutually between the communication device 10 and the electronic device 12 through the first wireless communication unit 102 and the second wireless communication unit 120, respectively. The control unit 100 determines whether the connection state between the mobile communication device 10 and the electronic device 12 is normal according to the periodically transmitted packet signals, and simultaneously calculates the signal strength to determine the distance between the mobile communication device 10 and the electronic device 12.

When the control unit 100 determines that the connection state between the mobile communication device 10 and the electronic device 12 is normal according to the packet signals, the control unit 100 generates a turning-on signal and wirelessly transmits the turning-on signal to the electronic device 12 so as to control the electronic device 12 to be turned on. Otherwise, when the connection state is determined to be abnormal by the control unit 100, a turning-off signal is generated and wirelessly transmitted to the electronic device 12 such that the electronic device 12 is controlled to be turned off. In the exemplary embodiment of the instant disclosure, the electronic device 12 further comprises a control unit 122 connected to a power unit 124. The control unit 122 is used for receiving a turning-on signal and a turning-off signal received by the second wireless communication unit 120 and launches the power unit 124 to turn on the electronic device 12 upon receiving the turning-on signal and shuts down the power unit 124 to turn off the electronic device 12 upon receiving the turning-off signal.

Specifically, the control unit 100 determines whether the connection state is normal according to the packet signals transmitted mutually between the mobile communication device 10 and the electronic device 12. For example, the control unit 100 determines whether the packet signals transmitted from the electronic device 12 is received within a predetermined period, or periodically compares the signal strength with a predetermined signal strength threshold so as to determine whether the connection state is normal.

For example, when the distance between the mobile communication device 10 and the electronic device 12 is within a connectable distance, both devices can receive the packet signals from each other and are wirelessly connected with each other. The mobile communication device 10 continuously receives the packet signals from the electronic device 12, thus making the control unit 100 determine that the connection state between the mobile communication device 10 and the electronic device 12 is normal. Besides, if determination of the connection state is according to the signal strength, the control unit 100 calculates the signal strength according to the received responsive packet signals from the electronic device 12 after the mobile communication device 10 transmits the packet signals to the electronic device 12. When the calculated signal strength is larger than the predetermined threshold, the connection state between the mobile communication device 10 and the electronic device 12 is determined to be normal, so that the electronic device 12 is controlled to be turned on.

Since the signal strength is affected by the distance between both devices. The shorter the distance between both devices is, the stronger the signal strength is. In contrast, when two devices are farther away from each other, the signal strength attenuates more, and the mobile communication device 10 is not disconnected with the electronic device 12 until the distance exceeds the connection range for which the transmitted packet signals can not be received by each other. Therefore, the connection state in the instant disclosure may vary according to the variation of the distance between the mobile communication device 10 and the electronic device 12. Specifically, when two devices are located too far apart from each other resulting in too low signal strength or even connection interruption, the control unit 100 determines that the connection state is abnormal.

In the exemplary embodiment of the instant disclosure, the mobile communication device 10 further comprises a storage unit 106 and a display unit 108. The storage unit 106 stores parameters data necessary for the application program. When the application program is initiated, the control unit 100 executes the communication instructions in the application program to accomplish above wireless connection, determination for the connection state, and the control for turning on/off the electronic device 12. The application program further provides setting pages displayed on the display unit 108 for the user to set a predetermined distance corresponding to the controlled electronic device 12 and to set the certification information necessary for controlling the electronic device 12.

In the exemplary embodiment of the instant disclosure, after the mobile communication device 10 is connected with the electronic device 12 located within the connection range, the user can further set on setting pages the predetermined distance corresponding to the electronic device 12 to determine turning on/off the electronic device 12, wherein the predetermined distance is shorter than the radius of the connection range. When the predetermined distance corresponding to the electronic device 12 is set, in a process during which the control unit 100 determines whether the connection state is normal, the control unit 100 periodically determines whether the calculated signal strength is larger than the predetermined threshold. Besides, the control unit 100 also calculates the relative distance between the mobile communication device 10 and the electronic device 12 according to the signal strength and bit error rate of bi-directionally transmitted packet signal, and compares whether the relative distance is smaller or equal to the predetermined distance. If both the connection state is normal and the relative distance is within the predetermined distance, the control unit 100 transmits the turning-on signal to turn on the electronic device 12. Otherwise, the control unit 100 does not control the electronic device 12 to be turned on even if the electronic device 12 is located within the connection range of the mobile communication device 10 but the relative distance is longer than the predetermined distance. Thereby the user may utilize the mobile communication device 10 to control the electronic device 12 flexibly to save the electrical power efficiently according to demand of the user. For example, the controlled electronic device is a television, and the mobile communication device 10 is wirelessly connected with the electronic device 10 through each Bluetooth unit thereof. Even if the connectable distance between the Bluetooth units is about 10 meters, the user may set the predetermined distance corresponding to the television to be 5 meters, so that the control unit 100 may control the television to be turned on only when the relative distance between the television and the mobile communication device 10 is within 5 meters.

Besides, in order to avoid that anyone has authorization to control the electronic device 12, the user may utilize the setting pages to set the certification information, so that only when the authorized user is utilizing the mobile communication device 10 the electronic device 12 is permitted to be controlled to turn on/off. Therefore, please refer to FIG. 1, in the exemplary embodiment of the instant disclosure, the mobile communication device 10 further comprises an input unit 104 for the user to input the certification information. For example, the input unit 104 may be a keyboard for the user to key-in the characters. The input unit 104 may also be a touching panel for receiving the characters or the figures, inputted from the gestures of the user, on the touching panel, e.g. clicking, writing, or portraying. The input unit 204 may also be a voice-receiving unit, for example, a microphone, for receiving the voice from the user as the certification information. Thereby the certification information may be set as words, figures, or voice. The control unit 100 may firstly request the user to input words, figures, or voice, then determines whether the certification information inputted from the input unit 104 by the user is correct. After the control unit 100 determines that the certification information is correctly inputted, the control unit controls the electronic device 12 to be turned on/off according to the distance between the mobile communication device 10 and the electronic device 12.

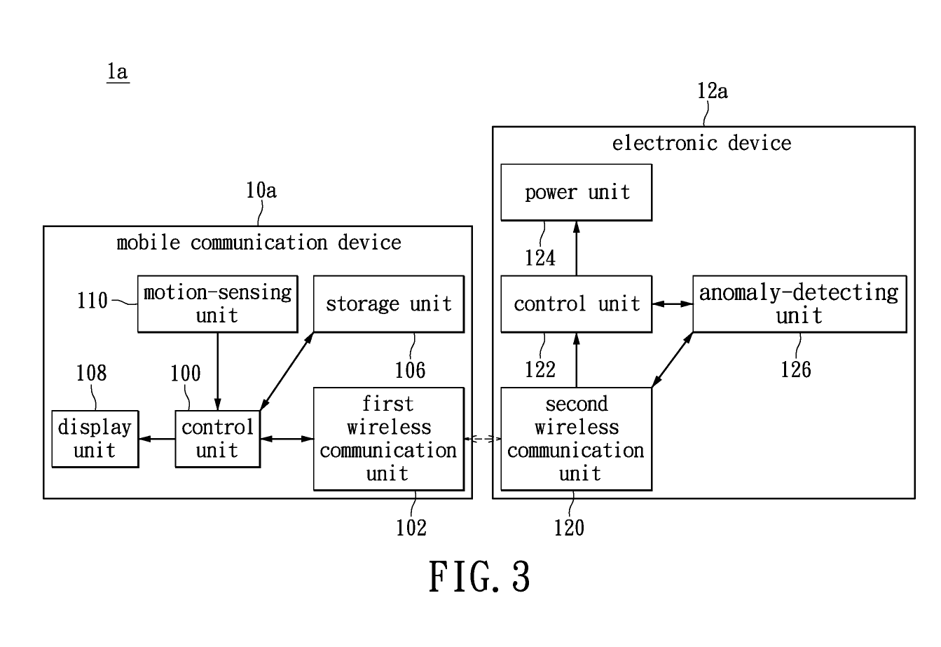

Please refer to FIG. 3. FIG. 3 shows a block diagram illustrating another control system for automatically turning on/off device. In the exemplary embodiment of the instant disclosure, a control system la for automatically turning on/off device also comprises a mobile communication device 10a and at least one electronic device 12a. The mobile communication device 10a further comprises a motion-sensing unit 110 except a control unit 100, a first wireless communication unit 102, a storage unit 106, and a display unit 108. The electronic device 12a further comprises an anomaly-detecting unit 126 except a second wireless communication unit 120 and a control unit 122.

In the exemplary embodiment of the instant disclosure, the certification information for certifying the user's control authority may be generated from a gesture or an action of the user. The motion-sensing unit 110 in the mobile communication unit 10a is used for sensing the action of the user to generate the certification information, which is transmitted to the control unit 100 for determining whether the certification information is correct. The motion-sensing unit 110 may be a gravity sensor or a gyroscope for sensing the actions like moving, or tilting the mobile communication device 10a, etc, by the user to form the certification information.

Besides, when the mobile communication device 10a searches multiple electronic devices 12a located within the connection range at the same time, the mobile communication device 10a may be respectively connected with the second wireless communication unit 120 of each electronic device 12a through the first wireless communication unit 102 and periodically transmit the packet signals mutually between the mobile communication device 10a and each connected electronic device 12a, so that the control unit 100 can determine whether the mobile communication device 10a is connected with the electronic device 12a or not and then further determine whether the connection state between the mobile communication device 10a and each electronic device 12a is normal.

Besides, the control unit 100 further displays the identification information (such as the name of the device) of the connected electronic device 12a on setting pages of the display unit 108, so that each electronic device 12a is determined to be turned on/off according to a predetermined distance, instead of the fact that the user sets the corresponding predetermined distance for each electronic device 12a.

The predetermined distance corresponding to each electronic device 12a is varied according to difference in types or purposes of the electronic devices 12a. The identification information of each electronic device 12a and the corresponding predetermined distance are stored in the storage unit 106, providing the control unit 100 to periodically determine whether the relative distance between the mobile communication device 10a and each electronic device 12a is smaller than or equal to the corresponding predetermined distance. When the relative distance(s) between one or more of the electronic devices 12a and the mobile communication device 10a is(are) smaller than or equal to the corresponding predetermined distance, the control unit 100 respectively transmits the turning-on signals to turn on one or more of the electronic devices 12a. Otherwise, when the relative distance between the mobile communication device 10a and the enabled electronic device 12a exceeds the corresponding predetermined distance, the control unit 100 transmits the turning-off signal to turn off the enabled electronic device 12a.

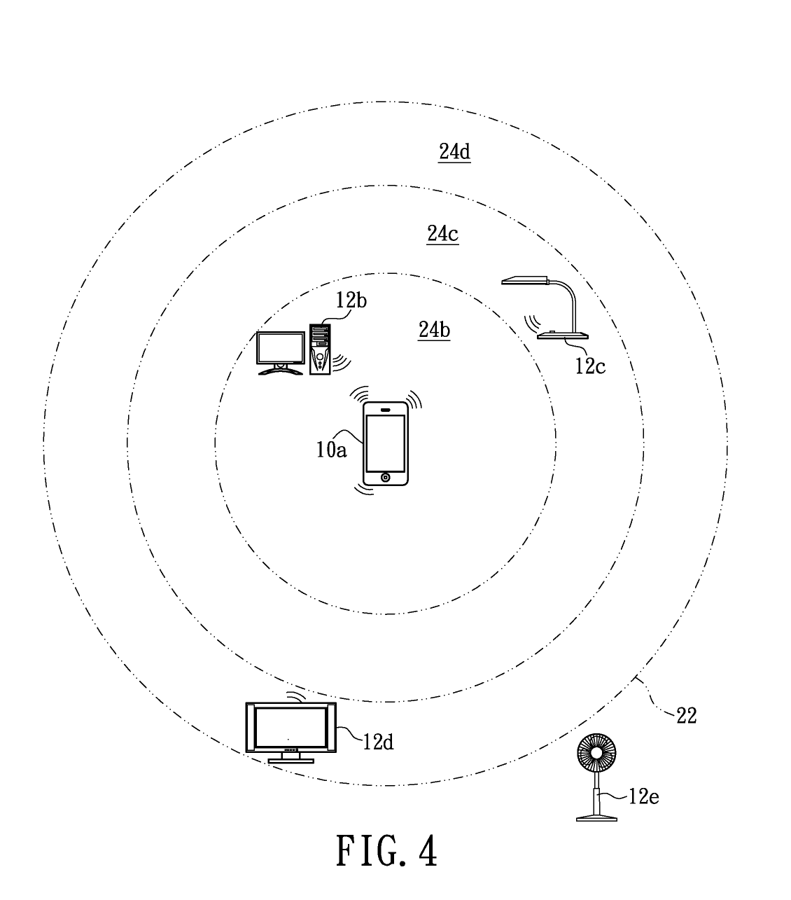

Please refer to FIG. 4. FIG. 4 shows a schematic view illustrating a mobile communication device 10a and multiple electronic devices 12b to 12e in the exemplary embodiment of the instant disclosure, wherein the connection range of the mobile communication device 10a is the area enclosed by a circle with a center at the mobile communication device 12a and a radius from the mobile communication device 12a to the boundary 22. The connection range of the mobile communication device 10a includes sequentially the connection ranges 24b, 24c, and 24d. It is supposed that the radius of the connection range of the mobile communication device 10a is 10 meters, the connection region 24b is the area enclosed by a circle with a radius of 4 meters, the connection region 24c is the area between a circle with a radius of 7 meters and a circle with a radius of 4 meters, and the connection range 24d is the area between a circle with a radius of 10 meters and a circle with a radius of 7 meters. As shown in FIG. 4, the electronic device 12b is located within the connection range 24b, the electronic device 12c is located within the connection range 24c, the electronic device 12d is located within the connection range 24d, and the electronic device 12e is located outside the connection range 24d.

When the wireless communication function of the mobile communication device 10a is enabled, the electronic devices located within the connection range are searched to be connected. In the exemplary embodiment of the instant disclosure, the electronic devices that can be searched include the electronic device 12b to 12d. Since the electronic device 12e is located outside the boundary 22 of the connection range, it fails to be searched by the mobile communication device 10a and thus can not be controlled by the mobile communication device 10a to turn on/off. After the mobile communication device 10a is wirelessly connected with the electronic devices 12b to 12d respectively, the mobile communication device 10a periodically determines whether the connection state between the mobile communication device 10a and each electronic device 12b to 12d is normal. If the predetermined distances corresponding to each electronic device 12b to 12d are recorded in the storage unit 106 (refer to FIG. 3) and the respective connection state is normal, the control unit 100 further determines whether the relative distance between the mobile communication device 10a and each electronic device 12b to 12d is within the corresponding predetermined distance, so as to determine to turn on/off the corresponding electronic devices 12b to 12d.

It is supposed that the predetermined distance corresponding to the electronic device 12b, 12c, and 12d is 5 meters, 8 meters, and 6 meters, respectively. According to the assumption in the exemplary embodiment of the instant disclosure, both the relative distances between the mobile communication device 10a and the electronic devices 12b and 12c are smaller than the corresponding predetermined distance, and the relative distance between the mobile communication device 10a and the electronic device 12d exceeds the corresponding predetermined distance. Thereby the mobile communication device 10a generates only the turning-on signals transmitted to the electronic devices 12b and 12c respectively, so as to control the electronic devices 12b and 12c to turn on the power supply. In contrast, the electronic device 12d for which the relative distance exceeds the predetermined distance fails to receive the turning-on signal that is indicated by the mobile communication device 10a to turn on the power supply.

Since the mobile communication device 10a periodically determines the variation of the distance between the mobile communication device 10a and the electronic devices 12b to 12d, thus the relative distance between the mobile communication device 10a and each electronic device 12b to 12e is also varied respectively if the mobile communication device 10a is moved resulting in variation of its location. The control unit 100 continues searching the electronic devices (e.g. 12e) within the connection range to connect them, and compares the relative distance between the mobile communication device 10a and the connected electronic device with the corresponding predetermined distance. According to the result of comparison, the control unit 100 may control another electronic device (e.g. 12d) to be turned on, or control the originally enabled electronic devices (e.g. 12b and 12c) to be turned off.

Please return to FIG. 3, it is worth mentioning that the electronic device 12a may utilize the anomaly-detecting unit 126 to detect by itself whether the electronic device 12a is abnormal. When the abnormal state occurs, an anomaly notice is transmitted to the connected mobile communication device 10a through the second wireless communication unit 120. The mobile communication device 10a displays the received anomaly notice on the display unit 10 for informing the user. At the same time, the control unit 100 controls the electronic device 12a to turn off the power supply according to the received anomaly notice or the instructions inputted from the user after the anomaly is found. If the anomaly-detecting unit 126 detects that the electronic device 12a has an anomaly and the electronic device 12a is not wirelessly connected with the mobile communication device 10a, the power supply of the electronic device 12a may be shut down actively by the control unit 122 itself to prevent the electronic device 12a from damage due to anomaly. The anomaly may be that the voltage of the electronic device 12a is too low.

Besides, as described in the aforementioned embodiment, the control unit 100 may control the electronic device 12 to be turned on/off when the application program is initiated, wherein the control unit 100 may further determine whether the wireless communication function of the first wireless communication unit 102 is enabled when the application program is initiated. If the wireless communication function is not enabled yet, the control unit 100 firstly controls the first wireless communication unit 102 to enable the wireless communication function so as to execute the process of searching the electronic device to be connected. When the user selects shutting down the application program to halt that the mobile communication device 10a is utilized to control the electronic device 12a to be turned on/off, the control unit 100 may also determine whether, except the electronic device 12a, there are other electronic devices whose power supplies are not controlled by the mobile communication device 10a. For example, the other electronic devices wirelessly connected with the mobile communication device 10a may be a data-input device like the wireless keyboard or a data-output device like the wireless earphone. If there are other electronic devices wirelessly connected with the mobile communication device 10a, the control unit will not disable the first wireless communication unit 102 when the control unit shuts down the application program, in order to make the mobile communication device 10a maintain a normal connecting with other electronic devices. Otherwise, if there are no other electronic devices connected with the mobile communication device 10a, the control unit 100 disables the wireless communication function when shutting down the application program for saving electrical power.

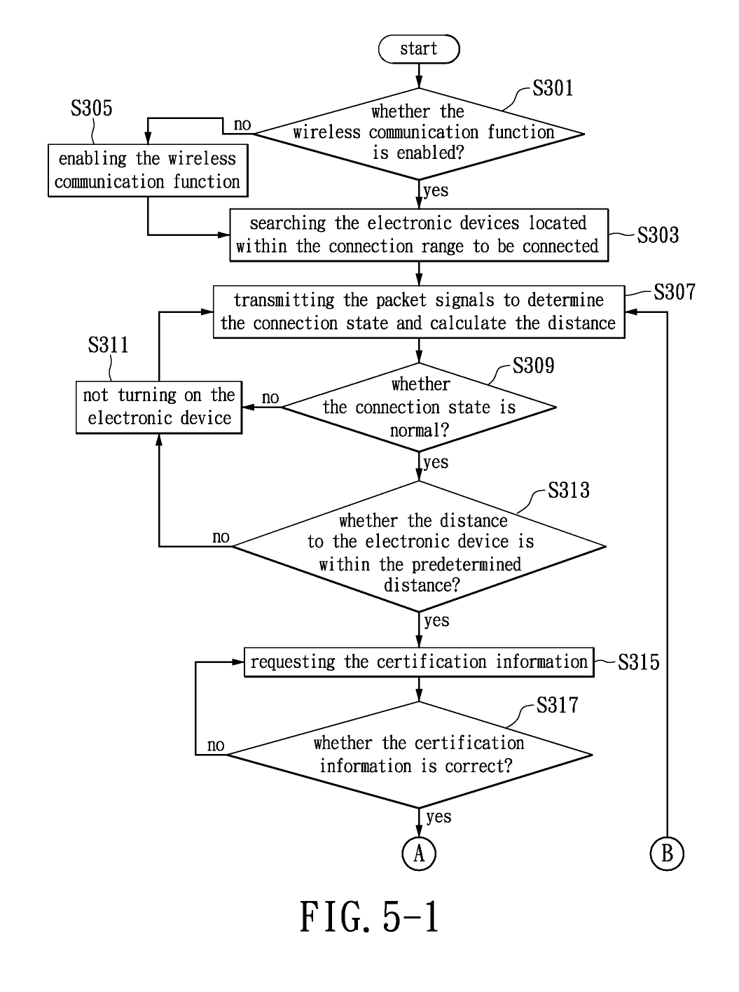

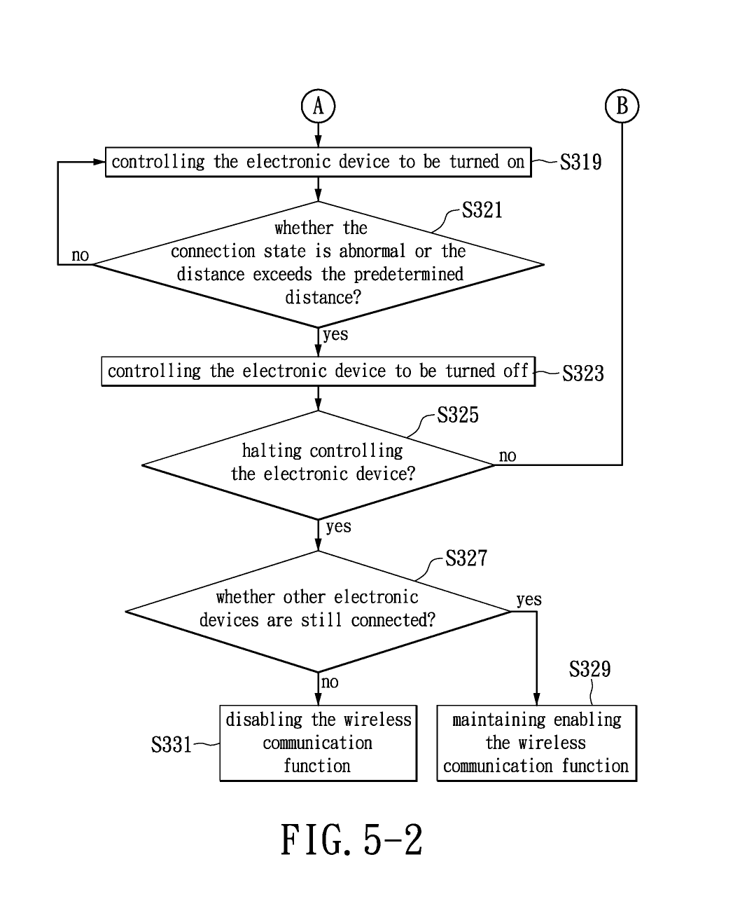

Please refer to FIG. 5-1 and FIG. 5-2. FIG. 5-1 and FIG. 5-2 show a flowchart of a method for automatically turning on/off device in the exemplary embodiment of the instant disclosure. In order to conveniently describe the following steps, please also refer to the devices and the elements as shown in FIG. 1.

The mobile communication device 10 initiates a stored application program according to the instructions from the user, and executes the application program to control at least one electronic device 12 to be turned on/off. After the application program is initiated, the control unit 100 firstly determines whether the wireless communication function is enabled (S301). If the wireless communication function is enabled, the control unit 100 controls the first wireless communication unit 102 to search and connect within the connection range the electronic devices 12 which have wireless communication function and have been enabled (S303). If the wireless communication function of the mobile communication device 10 has not been enabled, the control unit 100 firstly controls the first wireless communication unit 102 to enable the wireless communication function (S305), and then starts to search and connect the electronic devices (S303).

After the mobile communication device 10 is wirelessly connected with the electronic device 12, the packet signals are periodically transmitted mutually between the first wireless communication unit 102 and the second wireless communication unit 120 for determining the connection state and calculating the distance (S307). The control unit 100 determines whether the connection state is normal according to the packet signals and the calculated signal strength (S309). If the connection state is abnormal, the control unit 100 does not control the electronic device 12 to be turned on (S311), and the control unit 100 continues periodically transmitting the packet signals (return to S307) and calculating the signal strength to obtain a new connection state. If the connection state is normal, the control unit 100 further determines whether the relative distance between the mobile communication device 10 and the electronic device 12 is within the predetermined distance (S313).

When the relative distance between the mobile communication device 10 and the electronic device 12 is determined to be longer than the predetermined distance, the control unit 100 also does not control the electronic device 12 to be turned on (S311). On the contrary, when the relative distance between the mobile communication device 10 and the electronic device 12 is shorter than or equal to the predetermined distance, the control unit 100 controls the electronic device 12 to be turned on. Before the electronic device 12 is turned on, the control unit 100 may further request the user for providing the certification information (S315) so as to avoid the user without authorization utilizing the mobile communication device 10 to control the electronic device 12. The control unit 100 determines whether the certification information is correct (S317). If the certification information is incorrect, the control unit 100 further requests the user to provide the correct certification information (return to S315). Only after the certification information is correct, the control unit 100 transmits the turning-on signal to the electronic device 12 through the first wireless communication unit 102 and controls the electronic device 12 to be turned on (S319).

After the electronic device 12 is turned on, the control unit 100 continues determining whether the connection state between the mobile communication device 10 and the connected electronic device 12 is normal, and determining whether the relative distance between the mobile communication device 10 and the connected electronic device 12 exceeds the predetermined distance (S321). If the connection state between the mobile communication device 10 and the connected electronic device 12 is normal and the relative distance is within the predetermined distance, the electronic device 12 is controlled to maintain in a turned-on state (return to S319). If the relative distance between the mobile communication device 10 and the electronic device 12 becomes longer resulting in that the connection state is abnormal or the relative distance exceeds the predetermined distance, the control unit 100 controls the electronic device to be turned off (S323). Thereby the mobile communication device 10 determines to turn on/off the electronic device 12 according to relative distance between the mobile communication device 10 and the electronic device 12. Specifically, when the mobile communication device 10 is moved close to the electronic device 12 such that the distance between the mobile communication 10 and the electronic device 12 is near the predetermined distance, the mobile communication device 10 turns on the electronic device 12. Otherwise, when the mobile communication device 10 is moved far away from the electronic device 12 such that the distance between them exceeds the predetermined distance, the mobile communication device 10 turns off the electronic device 12.

Besides, the control unit 100 further determines whether to halt controlling the electronic device 12 or not (S325). For example, when the mobile communication device 10 is moved far away from the electronic device 12 such that the electronic device 12 is turned off, the control unit further determines whether the instructions from the user are received for shutting down the application program. If the control unit 100 does not receive the instructions and determines to halt controlling the electronic device 12, the next step is returned to step S307. If the control unit 100 receives the instructions and determines to halt controlling the electronic device 12 to be turned on/off, the control unit 100 further determines whether there are other electronic devices wirelessly connected with the mobile communication device 10 through the first wireless communication unit 102 (S327). If there are other electronic devices wirelessly connected with the mobile communication device 10, the control unit 100 only shuts down the application program to halt controlling the electronic device 12 whereas the wireless communication function of the first wireless communication unit 102 maintains enabled (S329). When the control unit 100 shuts down the application program to halt controlling the electronic device 12 and there are no other electronic devices wirelessly connected with the mobile communication device 10, the control unit 100 may also disable the wireless communication function of the first wireless communication unit 102 (S331) for avoid wasting the electrical power.

Specially, the flowchart shown in FIG. 5-1 and FIG. 5-2 is one method of the exemplary embodiments of the instant disclosure. In other embodiment, the steps S313 and S321 for determining whether the relative distance between the mobile communication device 10 and the electronic device 12 is within the predetermined distance belong to non-essential steps. Besides, the steps S327 and S331 for determining whether to disable the wireless communication function when the application program is shut down also belong to non-essential steps. The steps 5315 to 5317 for requesting the correct certification information may also be omitted or executed ahead.

According to the exemplary embodiment of the present invention, the aforementioned control system and method for automatically turning on/off device provides electronic devices which are controlled to be timely turned on/off by the mobile communication device. Specifically, the variation of the distance between the mobile communication device and the controlled electronic devices is utilized to determine turning on/off the electronic device. Most users have a habit of being accompanied with a mobile communication device. Specifically, when the user moves close to the operated electronic device, the electronic device is automatically turned on. Otherwise, the electronic device is automatically turned off when the user moves away from the operated electronic device. Therefore, the aforementioned control system and method can greatly enhance the convenience of operating the electronic device for the user.

Besides, according to the control system and method in the exemplary embodiment of the present invention, different predetermined distances may be set according to difference in types or purposes of the controlled electronic device for more precisely controlling the electronic device to be turned on/off according to the variation of the distance. Thereby the consumption of the electrical power is efficiently controlled to avoid wasting the electrical power.

Additionally, the control system and method in the exemplary embodiment of the present invention further provides an authorization-certifying mechanism for verifying the certification information to permit or forbid whether the mobile communication device may be utilized to control the electronic device. Thereby the consumption of the electrical power may be saved by avoiding randomly turning-on the electronic devices, and the one without authorization is also prevented from randomly utilizing the mobile communication to control the electronic device.

It is worth mentioning that according to the control system and method in the exemplary embodiment of the present invention, the electronic devices include the mechanism of self-detecting, self-warning, and self-shutting down, and the anomaly notice may be indicated through the connected mobile communication device, thus the effect of providing warning and protection for the electronic devices can be attained, so as to prevent the electronic devices from damage.

The descriptions illustrated supra set forth simply the preferred embodiments of the present invention; however, the characteristics of the present invention are by no means restricted thereto. All changes, alternations, or modifications conveniently considered by those skilled in the art are deemed to be encompassed within the scope of the present invention delineated by the following claims.

What is claimed is:

1. A control system for automatically turning on/off device, comprising:
at least an electronic device; and
a mobile communication device, comprising:
a wireless communication unit, used for wirelessly connecting with the electronic device and transmitting the packet signals mutually between the wireless communication unit and the electronic device; and
a control unit, determining whether a connection state between the mobile communication device and the electronic device is normal according to the packet signals, and controlling the electronic device to be turned on when the connection state is normal and controlling the electronic device to be turned off when the connection state is abnormal;
wherein the connection state is varied in accordance with a distance between the mobile communication device and the electronic device.

2. The control system for automatically turning on/off device according to claim 1, wherein the control unit determines that the connection state is abnormal when the wireless communication unit has not received the packet signals transmitted from the electronic device.

3. The control system for automatically turning on/off device according to claim 1, wherein the control unit determines whether the distance between the mobile communication device and the electronic device is within a predetermined distance according to the connection state, and controls the electronic device to be turned on when the distance is within the predetermined distance and controls the electronic device to be turned off when the distance exceeds the predetermined distance.

4. The control system for automatically turning on/off device according to claim 1, wherein when the quantity of the electronic device is more than one, the distance between the mobile communication device and each one of the electronic devices is corresponding to a respective predetermined distance, wherein the control unit determines whether the distance between the mobile communication device and each one of the electronic devices is within the corresponding predetermined distance and controls each one of the electronic devices to be turned on when the distance is within the corresponding predetermined distance.

5. The control system for automatically turning on/off device according to claim 1, wherein the control unit determines whether the wireless communication unit is enabled, and the wireless communication device searches the electronic device to be connected when the wireless communication unit is determined enabled, and the control unit controls the wireless communication unit to be enabled when the wireless communication unit is determined disabled.

6. The control system for automatically turning on/off device according to claim 4, wherein the control unit disables the wireless communication unit when the control unit halts controlling the electronic device and there are no other devices wirelessly connected with the mobile communication device except the electronic device, and the control unit does not disable the wireless communication unit when the control unit halts controlling the electronic device whereas there are other devices wirelessly connected with the mobile communication device except the electronic device.

7. The control system for automatically turning on/off device according to claim 1, wherein the mobile communication device further comprises an input unit for transmitting a certification information from the input unit to the control unit, the control unit controls the electronic device to be turned on/off when the certification information is verified to be correct, wherein the certification information is characters, figures, or vocal data.

8. The control system for automatically turning on/off device according to claim 1, wherein the mobile communication device further comprises a motion-sensing unit used for detecting an action originated from a user to generate a certification information and transmitting the certification information to the control unit, and the control unit controls the electronic device to be turned on/off when the certification information is verified to be correct.

9. A control method for automatically turning on/off device, wherein a mobile communication device controls at least an electronic device to be turned on/off, the control method comprising:
wirelessly connecting with the electronic device, and transmitting the packet signals mutually between the mobile communication device and the electronic device;
determining whether a connection state between the mobile communication device and the electronic device is normal according to the packet signals, wherein the connection state is varied in accordance with the distance between the mobile communication device and the electronic device;
controlling the electronic device to be turned on when the connection state is normal; and
controlling the electronic device to be turned off when the connection state is abnormal.

10. The control method for automatically turning on/off device according to claim 9, wherein the step for determining whether the connection state between the mobile communication device and the electronic device is normal comprises:
determining whether the mobile communication device receives the packet signals transmitted from the electronic device; and
determining that the connection state is abnormal when the mobile communication device has not received the packet signals transmitted from the electronic device.

11. The control method for automatically turning on/off device according to claim 9, wherein the step for determining whether the connection state between the mobile communication device and the electronic device is normal comprises:
determining whether the distance between the mobile communication device and the electronic device is within a predetermined distance; and
determining that the connection state is normal when the distance between the mobile communication device and the electronic device is within the predetermined distance;

12. The control method for automatically turning on/off device according to claim 9, before the step for controlling the electronic device to be turned on, further comprising:
requesting a certification information;
determining whether the received certification information is correct;
permitting to control the electronic device when the certification information is correct; and
forbidding to control the electronic device when the certification information is incorrect.
